(19) United States
(12) Patent Application Publication
(10) Pub. No.: US 2009/0167215 A1
(43) Pub. Date: Jul. 2, 2009

(54) DISPLACEMENT-PREVENTING DEVICE FOR COILABLE SHADE

(76) Inventor: Jia Yih SHEU, Yong Kang City (TW)

Correspondence Address: Dr. BANGER SHIA;Int''l Patent Office of Bang Shia, 102 Lindencrest Ct, Sugar Land, TX, 77479-5201, US

(21) Appl. No.: 11/968,161

(22) Filed: Dec. 31, 2007

(51) Int. Cl. H02P 3/12

(52) U.S. Cl. 318/280

(57) ABSTRACT

A displacement-preventing device includes a control device electrically connected to an AC power source. The control device includes an upward movement contact, a downward movement contact, and a common contact. A power circuit is electrically connected to the common contact and converts the AC power source into a DC power source. A positing circuit is electrically connected to the control device, the power circuit, and the motor. The control device is operable to control rotation of the motor in either of two opposite directions for moving the coilable shade in the coiling direction or the uncoiling direction. The control device stops the motor when no power is input to the motor, and the positioning circuit causes a positive terminal of the motor to be in electrical connection with a negative terminal of the motor.

### BACKGROUND OF THE INVENTION

1. Field of the Invention

The present invention relates to a displacement-preventing device for a coilable shade and, more particularly, to a displacement-preventing device preventing displacement of a coilable shade when a motor driving the coilable shade is in an off state.

2. Description of the Related Art

A coilable shade is generally mounted around a reel or the like and can be movable in a coiling/winding or uncoiling/unwinding direction. Such a coilable shade can be utilized as a coilable screen or window shade. To provide easy coiling/uncoiling operation of the coilable shade, the reel can be driven by a shaft of a motor through a speed-reduction device. FIG. 7 shows a conventional circuitry diagram, wherein the positive and negative terminals of a motor M are connected to a power and control circuit 1. Alternating current power input is connected to an input side of the power and control circuit 1. The power and control circuit 1 includes a voltage-reducing/rectifying circuit for outputting DC current. The power and control circuit 1 includes a control device for controlling rotation of the motor M in either of two directions to coil or uncoil a shade. When the shade reaches a desired position, the motor M is turned off to retain the shade in place. However, since the coil of the motor M is not energized when the shade is stopped, undesired movement of the shade may occur in a case that the gravitational force acting on the uncoiled shade is larger than the braking force provided by the shaft and causes rotation of the shaft.

The motor M is generally a product with a certain specification in which the braking force of the shaft of the motor in the off state can be set. However, various shades have different lengths to match various sites and, thus, have different weights. As a result, the motor M generally can not withstand various shades of various weights such that undesired displacement of the shades occurs when the gravitational force acting on the uncoiled shade is larger than the preset braking force of the shaft of the motor in the off state.

### BRIEF SUMMARY OF THE INVENTION

An objective of the present invention is to provide a displacement-preventing device that can prevent undesired displacement of a coilable shade when a motor driving the coilable shade is in an off state.

A displacement-preventing device for a coilable shade according to the preferred teachings of the present invention includes a control device adapted to be electrically connected to an AC power source. The control device includes an upward movement contact, a downward movement contact, and a common contact. A power circuit is electrically connected to the common contact and converts the AC power source into a DC power source. The power circuit includes a positive output terminal and a negative output terminal. A DC motor includes a positive terminal and a negative terminal. The motor can be operated to move a coilable shade in a coiling direction or an uncoiling direction. A positing circuit is electrically connected to the control device, the power circuit, and the motor. The control device is operable to control rotation of the motor in either of two opposite directions for moving the coilable shade in the coiling direction or the uncoiling direction. The control device stops the motor when no power is input to the motor, and the positioning circuit causes the positive terminal of the motor to be in electrical connection with the negative terminal of the motor.

In the most preferred form, the positing circuit includes first, second, third, and fourth relays. Each of the first and second relays is in electrical connection with the upward movement contact and the common contact. Each of the third and fourth relays is in electrical connection with the downward movement contact and the common contact. Each of the first and third relays includes a normally-open contact in electrical connection with the power circuit. Each of the second and fourth relays includes a normally-open contact being in electrical connection with the positive output terminal of the power circuit. Each of the first and third relays includes a normally-closed contact free of electrical connection. The second relay further includes a normally-closed contact in electrical connection with the negative output terminal of the power circuit and the positive terminal of the motor. The fourth relay includes a normally-closed contact in electrical connection with the negative output terminal of the power circuit and the negative terminal of the motor.

When the shade is to be moved upward, the first and second relays become conductive. The AC power source is input to the power circuit via the upward movement contact, the normally-open contact of the first relay, and the common contact. The power circuit outputs DC current. The power at the positive output terminal of the power circuit is input to the positive terminal of the motor through the normally-open contact of the second relay. The negative output terminal of the power circuit is electrically connected to the negative terminal of the motor. The motor rotates in one of the two directions to move the shade upward.

When the shade is adapted to be moved downward, the third and fourth relays become conductive. The AC power source is input to the power circuit via the downward movement contact, the normally-open contact of the third relay, and the common contact. The power circuit outputs DC current. The power at the positive output terminal of the power circuit is input to the negative terminal of the motor through the normally-open contact of the fourth relay. The negative output terminal of the power circuit is electrically connected to the positive terminal of the motor. The motor rotates in the other direction to move the shade downward.

When no AC power source is input to the power circuit, the first, second, third, and fourth relays do not operate. The positive terminal of the motor is electrically connected to the negative terminal of the motor through the normally-closed contact of the second relay and the normally-closed contact of the fourth relay. The positive and negative terminals of the motor are in electrical connection with each other. A coil of the motor creates a reverse magnetic field preventing rotation of a shaft of the motor.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a schematic circuitry diagram of a displacement-preventing device for a coilable shade according to the preferred teachings of the present invention.

FIG. 2 shows a partial, perspective view of a shade and a motor for driving the shade according to the preferred teachings of the present invention.

FIG. 3 shows a detailed circuitry diagram of the displacement-preventing device of FIG. 1.

FIG. 4 is a view similar to FIG. 1, wherein the motor is in an on state for driving the shade upward.

FIG. 5 is a view similar to FIG. 1, wherein the motor is in an on state for driving the shade downward.

FIG. 6 is a view similar to FIG. 1, wherein the motor is in an off state.

FIG. 7 shows a conventional circuitry diagram for moving a coilable shade.

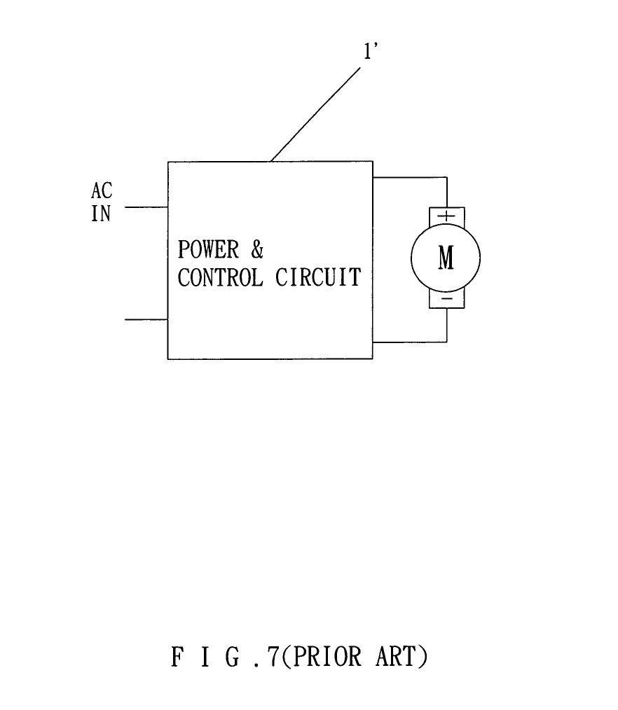

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

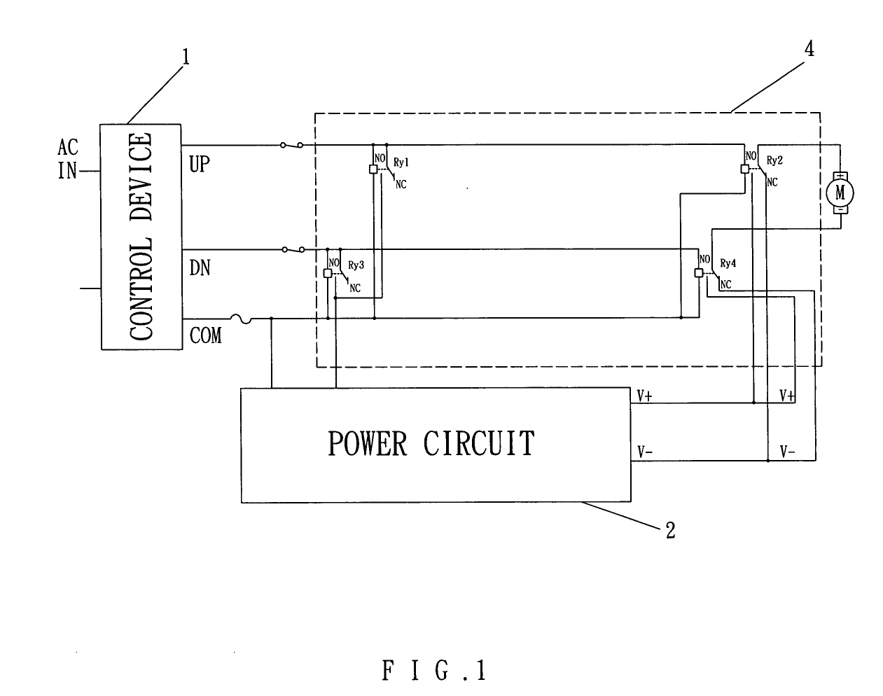

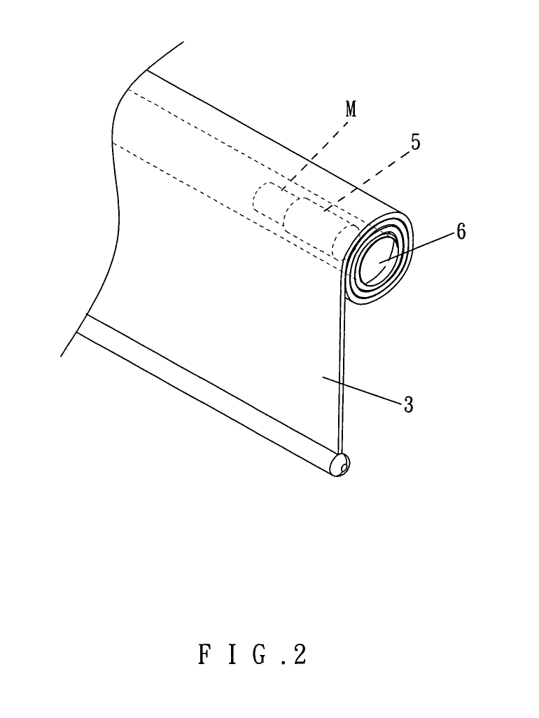

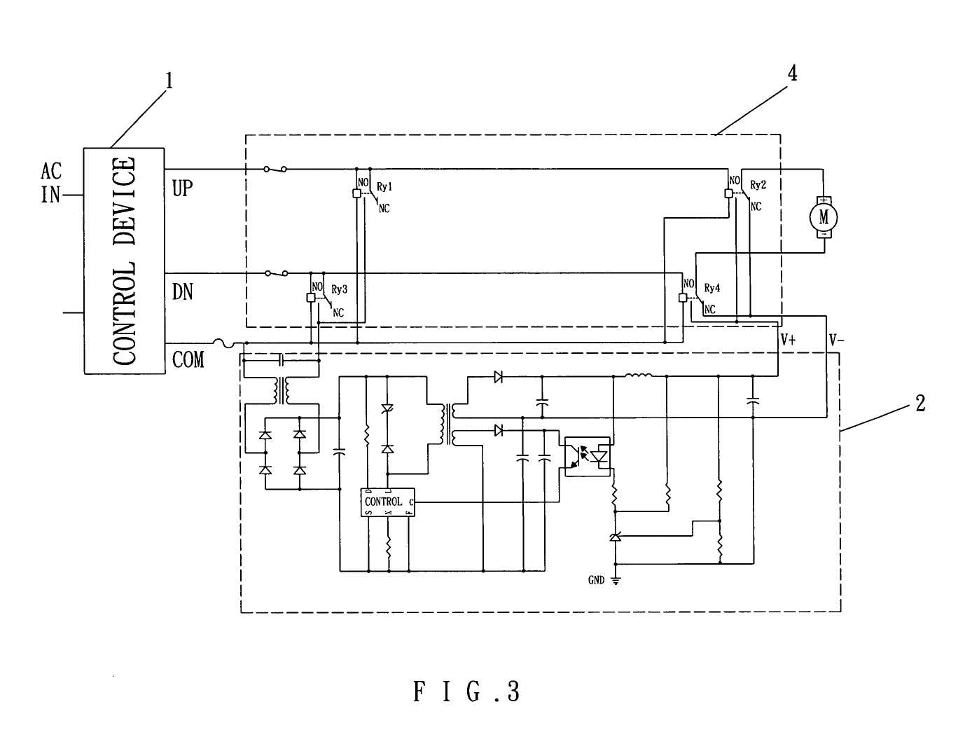

With reference to FIGS. 1-3, a displacement-preventing device for a coilable shade according to the preferred teachings of the present invention includes a control device 1, a power circuit 2, a motor M, and a positioning circuit 4. The displacement-preventing device is utilized to control coiling/uncoiling of a coilable shade 3 mounted around a reel 6. According to the preferred form shown, the reel 6 is tubular and receives the motor M. The motor M is a DC motor including positive and negative terminals. The motor M further includes a shaft coupled with a reduction device 5, which in turn, is coupled with the reel 6 via an output shaft. The motor M can be operated to control upward/downward (or coiling/uncoiling) movement of the shade 3. The control device 1 is electrically connected to an AC power source and includes an upward movement contact UP, a downward movement contact DOWN, and a common contact COM. When the upward movement contact UP and the common contact COM become conductive, the shade 3 can be moved upward. On the other hand, when the downward movement contact DOWN and the common contact COM become conductive, the shade 3 can be moved downward.

The power circuit 2 can convert input alternating current into DC current and is electrically connected to the common contact COM. The power circuit 2 includes a positive output terminal V+ and a negative output terminal V−. According to the preferred form shown, the power circuit 2 is an exchange-type power circuit that can reduce voltage and rectify current.

According to the preferred form shown, the positioning device 4 includes first, second, third, and fourth replays Ry1, Ry2, Ry3, and Ry4. The first relay Ry1 is electrically connected to the upward movement contact UP and the common contact COM. The second relay Ry2 is electrically connected to the upward movement contact UP and the common contact COM. The third relay Ry3 is electrically connected to the downward movement contact DOWN and the common contact COM. The fourth relay Ry4 is also electrically connected to the downward movement contact DOWN and the common contact COM. Each of the first replay Ry1 and the third relay Ry3 includes a normally-open contact No electrically connected to the power circuit 2. Each of the first replay Ry1 and the third replay Ry3 has a normally-closed contact Nc free of electrical connection. Each of the second and fourth relays Ry2 and Ry4 includes a normally-open contact No in electrical connection with the positive output terminal V+ of the power circuit 2. The second relay Ry2 includes a normally-closed contact Nc electrically connected to the negative output terminal V− of the power circuit 2 and the positive terminal of the motor M. The fourth relay Ry4 includes a normally-closed contact Nc electrically connected to the negative output terminal V− of the power circuit 2 and the negative terminal of the motor M.

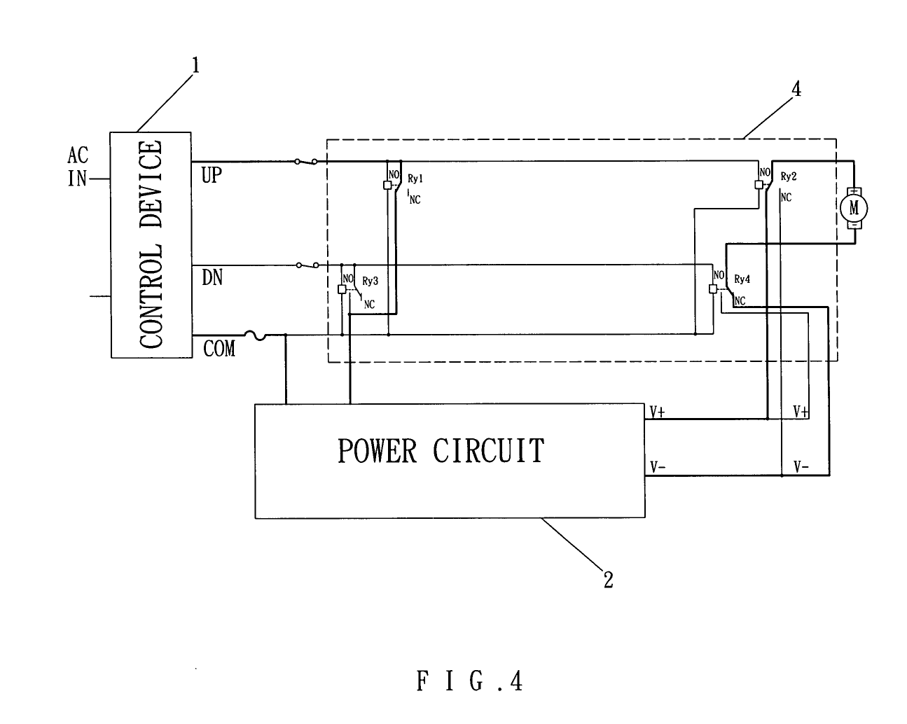

With reference to FIG. 4, when a user intends to move the shade 3 upward through control of the control device 1, the first and second relays Ry1 and Ry2 become conductive, and the AC power source is input to the power circuit 2 via the upward movement contact UP, the normally-open contact No of the first relay Ry1, and the common contact COM. The power circuit 2 outputs DC current. Furthermore, the power at the positive output terminal V+ of the power circuit 2 is input to the positive terminal of the motor M through the normally-open contact No of the second relay Ry2. Further, the negative output terminal V− of the power circuit 2 is electrically connected to the negative terminal of the motor M. The motor M can rotate in a direction to move the shade 3 upward. The flowing direction of the current is in shown by the bold lines in FIG. 4.

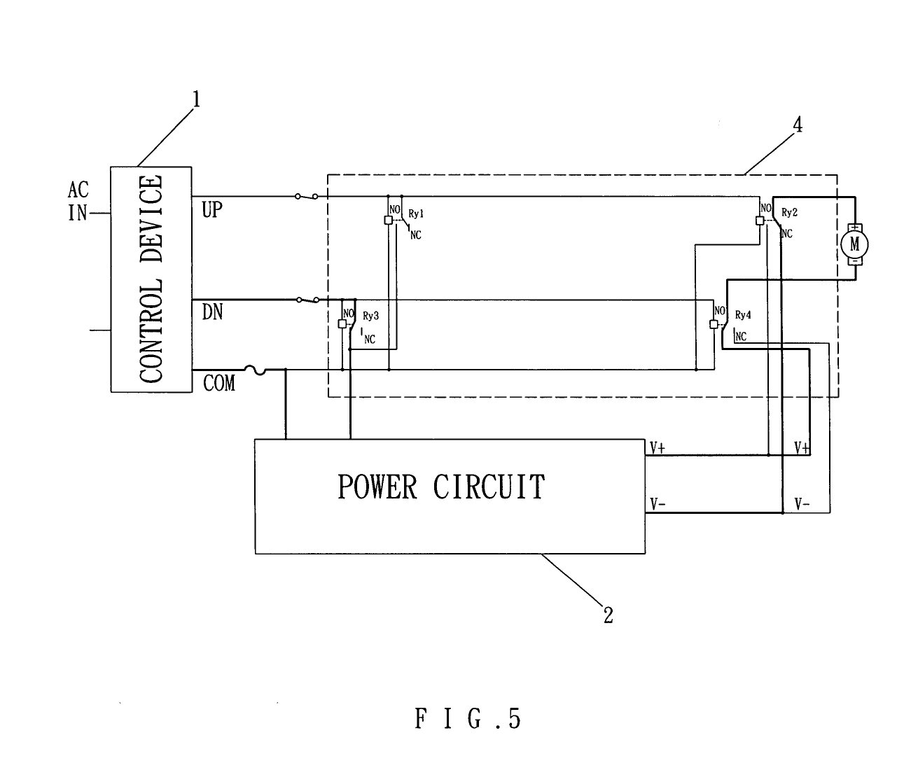

With reference to FIG. 5, when the user intends to move the shade 3 downward through control of the control device 1, the third and fourth relays Ry3 and Ry4 become conductive, and the AC power source is input to the power circuit 2 via the downward movement contact DOWN, the normally-open contact No of the third relay Ry3, and the common contact COM. The power circuit 2 outputs DC current. Furthermore, the power at the positive output terminal V+ of the power circuit 2 is input to the negative terminal of the motor M through the normally-open contact No of the fourth relay Ry4. Further, the positive output terminal V− of the power circuit 2 is electrically connected to the negative terminal of the motor M. The motor M can rotate in a reverse direction to move the shade 3 downward. The flowing direction of the current is in shown by the bold lines in FIG. 5.

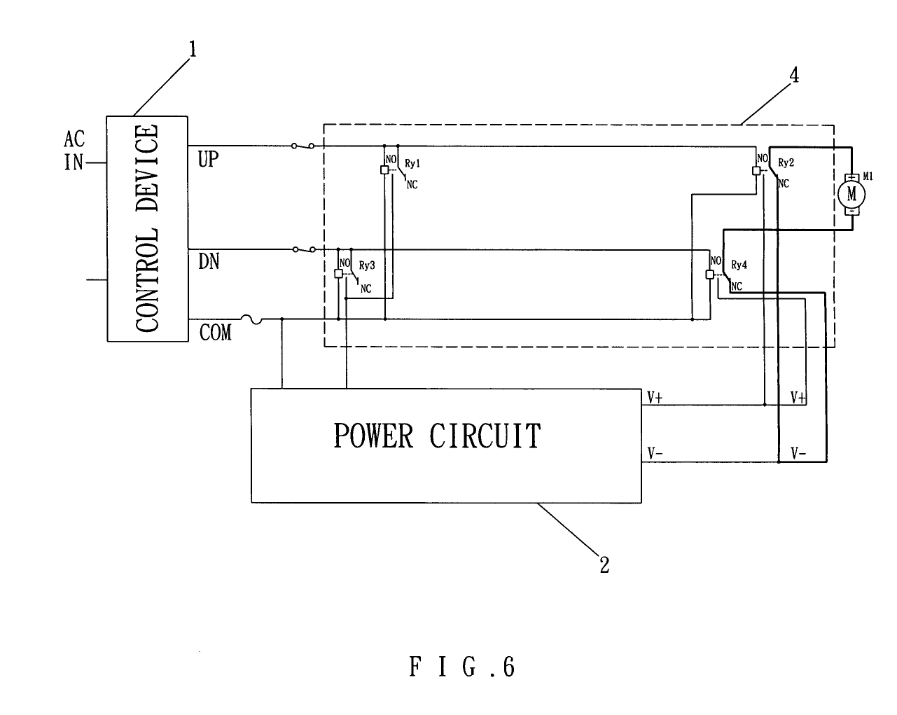

With reference to FIG. 6, after the shade 3 reaches the desired position, the control device 1 is not operated such that no AC power source is input to the power circuit 2. Furthermore, the first, second, third, and fourth relays Ry1, Ry2, Ry3, and Ry4 do not operate. Furthermore, the positive terminal of the motor M is electrically connected to the negative terminal of the motor M through the normally-closed contact Nc of the second relay Ry2 and the normally-closed contact Nc of the fourth relay Ry4. Thus, the positive and negative terminals of the motor M are in electrical connection shown by the bold lines in FIG. 6. Thus, a reverse magnetic field created by a coil of the motor M prevents rotation of the shaft of the motor M. The braking effect provided by the shaft of the motor M is larger than the gravitational force acting on the uncoiled shade 3. A reliable positioning effect for the shade 3 is, thus, provided.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A displacement-preventing device for a coilable shade comprising:
a control device adapted to be electrically connected to an AC power source, with the control device including an upward movement contact, a downward movement contact, and a common contact;
a power circuit electrically connected to the common contact and converting the AC power source into a DC power source, with the power circuit including a positive output terminal and a negative output terminal;
a DC motor including a positive terminal and a negative terminal, with the motor being adapted for moving a coilable shade in a coiling direction or an uncoiling direction; and
a positing circuit electrically connected to the control device, the power circuit, and the motor, with the control device being operable to control rotation of the motor in either of two opposite directions for moving the coilable shade in the coiling direction or the uncoiling direction, with the control device stopping the motor when no power is input to the motor, and with the positioning circuit causing the positive terminal of the motor to be in electrical connection with the negative terminal of the motor.

2. The displacement-preventing device for a coilable shade as claimed in claim 1, with the positing circuit including first, second, third, and fourth relays, with each of the first and second relays being in electrical connection with the upward movement contact and the common contact, with each of the third and fourth relays being in electrical connection with the downward movement contact and the common contact, with each of the first and third relays including a normally-open contact in electrical connection with the power circuit, with each of the second and fourth relays including a normally-open contact being in electrical connection with the positive output terminal of the power circuit, with each of the first and third relays including a normally-closed contact free of electrical connection, with the second relay further including a normally-closed contact in electrical connection with the negative output terminal of the power circuit and the positive terminal of the motor, and with the fourth relay including a normally-closed contact in electrical connection with the negative output terminal of the power circuit and the negative terminal of the motor.

3. The displacement-preventing device for a coilable shade as claimed in claim 2, wherein when the shade is adapted to be moved upward, the first and second relays become conductive, with the AC power source being input to the power circuit via the upward movement contact, the normally-open contact of the first relay, and the common contact, with the power circuit outputting DC current, with the power at the positive output terminal of the power circuit being input to the positive terminal of the motor through the normally-open contact of the second relay, with the negative output terminal of the power circuit being electrically connected to the negative terminal of the motor, and with the motor rotating in one of the two directions to move the shade upward.

4. The displacement-preventing device for a coilable shade as claimed in claim 3, wherein when the shade is adapted to be moved downward, the third and fourth relays become conductive, with the AC power source being input to the power circuit via the downward movement contact, the normally-open contact of the third relay, and the common contact, with the power circuit outputting DC current, with the power at the positive output terminal of the power circuit being input to the negative terminal of the motor through the normally-open contact of the fourth relay, with the negative output terminal of the power circuit being electrically connected to the positive terminal of the motor, and with the motor rotating in the other direction to move the shade downward.

5. The displacement-preventing device for a coilable shade as claimed in claim 4, wherein when no AC power source is input to the power circuit, the first, second, third, and fourth relays do not operate, with the positive terminal of the motor being electrically connected to the negative terminal of the motor through the normally-closed contact of the second relay and the normally-closed contact of the fourth relay, with the positive and negative terminals of the motor being in electrical connection with each other, and with the motor having a coil creating a reverse magnetic field preventing rotation of a shaft of the motor.
